(19) United States
(12) Patent Application Publication
(10) Pub. No.: US 2025/0309597 A1
(43) Pub. Date: Oct. 2, 2025

(54) INTERMEDIATE STRUCTURE AND STRUCTURE COMPRISING THE SAME

(71) Applicant: Japan Aviation Electronics Industry, Limited, Tokyo (JP)

(72) Inventor: Osamu HASHIGUCHI, Tokyo (JP)

(73) Assignee: Japan Aviation Electronics Industry, Limited, Tokyo (JP)

(21) Appl. No.: 19/055,678

(22) Filed: Feb. 18, 2025

(30) Foreign Application Priority Data
Mar. 29, 2024 (JP) 2024-056943

(51) Int. Cl. H01R 25/16; H01R 4/34

(52) U.S. Cl. CPC H01R 25/162; H01R 4/34

(57) ABSTRACT

A structure comprises an intermediated structure, a first busbar, a second busbar and a fastening member. The intermediated structure comprises a housing having a side wall and a terminal held by the housing. The terminal has a first connection portion, a second connection portion and a coupling portion. Under a fastened state where the fastening member is fastened, the first connection portion is connected to the first busbar, and the second connection portion is connected to the second busbar. The coupling portion is resiliently deformable and couples the first connection portion and the second connection portion together. One of the second busbar and the terminal has a pressed portion. Under the fastened state, the pressed portion bites the side wall in the second direction.

### CROSS REFERENCE TO RELATED APPLICATIONS

This application is based on and claims priority under 35 U.S.C. § 119 to Japanese Patent Application No. JP 2024-056943 filed Mar. 29, 2024, the content of which is incorporated herein in its entirety by reference.

### BACKGROUND OF THE INVENTION

This invention relates to an intermediate structure to which a busbar is configured to be connected via screw fastening and relates to a structure which comprises the intermediate structure.

JP2024-4006A (Patent Document 1) discloses a structure which can absorb misalignment between a busbar and a connection object. The content of Patent Document 1 is incorporated herein by reference.

Referring to FIGS. 26 and 27, Patent Document 1 discloses a connector 900 which comprises a terminal 910 and a busbar-fastening portion 920. The busbar-fastening portion 920 is fixed to an end of the terminal 910. The busbar-fastening portion 920 is formed with a fastening hole 922 through which a bolt 930 is configured to be fastened.

Patent Document 1 also discloses a busbar 950 which is connected to a connector-fastening portion 960 via a Z-shaped spring 970. The Z-shaped spring 970 has an end which is fixed to a nut 980. The nut 980 is fixed to an end of the busbar 950. The Z-shaped spring 970 has another end which is fixed to the connector-fastening portion 960. The busbar 950 and the connector-fastening portion 960 are also connected to each other via a wire 990 attached to the nut 980.

The connector-fastening portion 960 is formed with a fastening hole 962 through which the bolt 930 is configured to be fastened. The connector-fastening portion 960 is configured to be connected to the busbar-fastening portion 920 by fastening the bolt 930 with the nut 940 under a state where the connector-fastening portion 960 and the busbar-fastening portion 920 are stacked on each other.

The Z-shaped spring 970 which is arranged as described above can absorb misalignment between the busbar 950 and the terminal 910 of the connector 900.

However, when the aforementioned structure is used in a vibration environment, the members such as the Z-shaped spring 970 and the busbar 950 connected thereto will vibrate. As a result, noise might be generated, and the members such as the Z-shaped spring 970 might be damaged.

### SUMMARY OF THE INVENTION

It is therefore an object of the present invention to provide a structure which can reduce problems such as generation of noise even when used in a vibration environment.

An aspect of the present invention provides a structure comprising a fastening member, a first busbar, a second busbar and an intermediated structure. The fastening member has a shaft. The second busbar has a connection portion. The connection portion of the second busbar is formed with a hole portion. The intermediated structure is located between the first busbar and the second busbar and indirectly connects the first busbar and the second busbar to each other. The intermediated structure comprises a terminal and a housing. The housing has a side wall and is formed with an accommodation portion. The side wall extends in a first direction. The accommodation portion is adjacent to the side wall in a second direction perpendicular to the first direction. The housing holds the terminal which is at least partially accommodated in the accommodation portion. The terminal has a first connection portion, a second connection portion and a coupling portion. The coupling portion is resiliently deformable and couples the first connection portion and the second connection portion together. The first connection portion is connected to the first busbar. The second connection portion is formed with a passing hole. One of the second busbar and the terminal serves as a first member while a remaining one of the second busbar and the terminal serves as a second member. Hereinafter, the former is also referred to as the first member while the latter is also referred to as the second member. The first member is formed with a slit and has a pressed portion. The slit extends at least in the first direction through the connection portion of the first member or the second connection portion of the first member and communicates with the hole portion of the first member or the passing hole of the first member. The pressed portion is apart from the slit in the second direction and is movable in the second direction in accordance with a change in shape of the slit. The second member has a cylindrical projection. The cylindrical projection is formed integrally with the hole portion of the second member or the passing hole of the second member and extends along a third direction perpendicular to both the first direction and the second direction. The fastening member is under a fastened state where the fastening member is fastened. Under the fastened state, the shaft is received in both the hole portion and the passing hole and extends in a shaft direction intersecting with both the first direction and the second direction. Under the fastened state, the second connection portion is connected to the connection portion of the second busbar. Under the fastened state, the cylindrical projection is at least partially inserted in the hole portion of the first member or the passing hole of the first member and makes the slit wider, and the pressed portion at least partially bites the side wall in the second direction.

Another aspect of the present invention provides an intermediate structure configured to be located between the first busbar and the second busbar of the structure and to indirectly connect the first busbar and the second busbar to each other. The intermediated structure comprises a terminal and a housing. The housing has a side wall and is formed with an accommodation portion. The side wall extends in a first direction. The accommodation portion is adjacent to the side wall in a second direction perpendicular to the first direction. The housing holds the terminal which is at least partially accommodated in the accommodation portion. The terminal has a first connection portion, a second connection portion and a coupling portion. The coupling portion is resiliently deformable and couples the first connection portion and the second connection portion together. The first connection portion is configured to be connected to the first busbar. The second connection portion is formed with a passing hole. The second connection portion is configured to be connected to the second busbar. The second connection portion is movable in a third direction perpendicular to both the first direction and the second direction. The passing hole passes through the second connection portion in a direction intersecting with both the first direction and the second direction.

According to the structure of an aspect of the present invention, the resilient deformation of the coupling portion of the terminal can be used to absorb variation of a position of the connection portion of the second busbar when the fastening member is fastened. Moreover, the pressed portion of one of the second busbar and the terminal is pressed against and at least partially bites the side wall of the housing while the variation is absorbed. The aforementioned mechanism makes the second busbar and the terminal hardly movable. Accordingly, the structure of an aspect of the present invention can reduce damage of the second busbar and the terminal as well as generation of noise even when used in a vibration environment.

An appreciation of the objectives of the present invention and a more complete understanding of its configuration may be had by studying the following description of the preferred embodiment and by referring to the accompanying drawings.

### BRIEF DESCRIPTION OF THE DRAWINGS

FIG. 1 is a perspective view showing a structure according to a first embodiment of the present invention, wherein the structure is connected to third busbars.

FIG. 2 is a side view showing the structure of FIG. 1.

FIG. 3 is a cross-sectional view showing the structure of FIG. 1, taken along line III-III.

FIG. 4 is a cross-sectional view showing the structure of FIG. 2, taken along line IV-IV.

FIG. 5 is a top perspective view showing a second busbar included in the structure of FIG. 1.

FIG. 6 is a bottom perspective view showing the second busbar of FIG. 5.

FIG. 7 is a perspective view showing an intermediate structure included in the structure of FIG. 1.

FIG. 8 is an exploded, perspective view showing the intermediate structure of FIG. 7.

FIG. 9 is a cross-sectional view showing the intermediate structure of FIG. 7, wherein the illustrated cross-section corresponds to the cross-section of FIG. 4.

FIG. 10 is a front view showing a housing included in the intermediate structure of FIG. 7.

FIG. 11 is a cross-sectional view showing the housing of FIG. 10, taken along line XI-XI.

FIG. 12 is a rear view showing a terminal included in the intermediate structure of FIG. 7.

FIG. 13 is a bottom view showing the terminal of FIG. 12.

FIG. 14 is a side view showing the structure of FIG. 1, wherein the illustrated structure is under an assembly, and the third busbars are not illustrated.

FIG. 15 is a cross-sectional view showing the structure of FIG. 14, taken along line XV-XV.

FIG. 16 is a perspective view showing a structure according to a second embodiment of the present invention, wherein the structure is connected to the third busbars.

FIG. 17 is a cross-sectional view showing the structure of FIG. 16, taken along line XVII-XVII.

FIG. 18 is another cross-sectional view showing the structure of FIG. 16, wherein the illustrated cross-section corresponds to the cross-section of FIG. 4.

FIG. 19 is a top perspective view showing a second busbar included in the structure of FIG. 16.

FIG. 20 is a bottom perspective view showing the second busbar of FIG. 19.

FIG. 21 is a perspective view showing an intermediate structure included in the structure of FIG. 16.

FIG. 22 is an exploded, perspective view showing the intermediate structure of FIG. 21.

FIG. 23 is a cross-sectional view showing the intermediate structure of FIG. 21, wherein the illustrated cross-section corresponds to the cross-section of FIG. 4.

FIG. 24 is a side view showing the structure of FIG. 16, wherein the structure is under an assembly, and the third busbars are not illustrated.

FIG. 25 is a cross-sectional view showing the structure of FIG. 24, taken along line XXV-XXV.

FIG. 26 is a top view showing a connector of Patent Document 1.

FIG. 27 is a side view showing the connector of FIG. 26.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

### First Embodiment

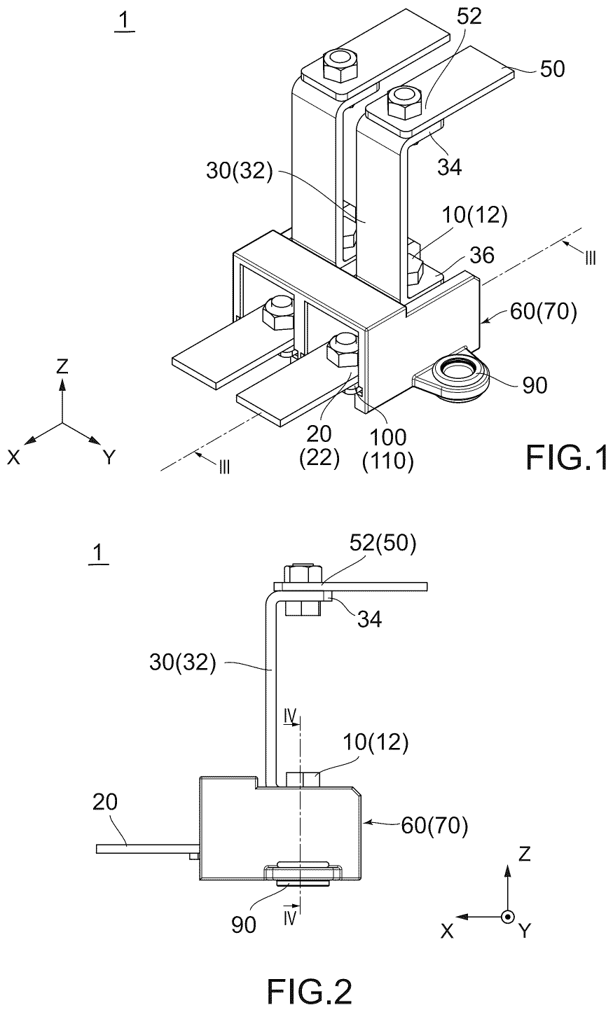

Referring to FIGS. 1 to 3, a structure 1 according to a first embodiment of the present invention comprises two fastening members 10, two first busbars 20, two second busbars 30, an intermediate structure 60 and two collars 90. The illustrated structure 1 is connected to two third busbars 50. Each of the first busbars 20 and the third busbars 50 is connected to an unillustrated object such as a device or a power source. Each of the illustrated first busbars 20 and the illustrated third busbars 50 extends along a first direction. The first direction of the present embodiment is the X-direction. The X-direction is also a front-rear direction. The positive X-direction means forward, and the negative X-direction means rearward.

The structure 1 of the present embodiment is formed with two current paths each of which extends from the first busbar 20 toward the third busbar 50, or from the third busbar 50 toward the first busbar 20, through the intermediate structure 60 and the second busbar 30. However, the present invention is not limited thereto. The number of the current paths may be one, three or more. The intermediate structure 60 and the other members described below may be modified depending on the current paths.

The aforementioned two current paths of the present embodiment are arranged in a second direction perpendicular to the first direction. The second direction of the present embodiment is the Y-direction. The Y-direction is also a lateral direction and a right-left direction. The positive Y-direction means rightward, and the negative Y-direction means leftward. The current paths of the present embodiment have configurations basically same as each other. Hereafter, explanation will be made about the configuration of the right current path unless otherwise stated.

As shown in FIGS. 1 to 3, the first busbar 20 and the third busbar 50 are apart from each other in a third direction perpendicular to both the first direction and the second direction. The third direction of the present embodiment is the Z-direction. The Z-direction is also an up-down direction. The positive Z-direction means upward, and the negative Z-direction means downward. The first busbar 20 is connected to an unillustrated first object such as a device or a power source. The third busbar 50 is connected to an unillustrated third object such as a device or a power source. The distance between the first object and the third object may vary in the third direction depending on their arrangements. The structure 1, particularly the intermediate structure 60, of the present embodiment is configured to absorb variation of the distance between the first object and the third object. As described later, the intermediate structure 60 of the structure 1 can reduce generation of noise which is a problem in the existing technique. Hereafter, explanation will be made mainly about the members of the structure 1 under a state where the structure 1 is not yet assembled, and then explanation will be made about an assembly method of the structure 1 and about the assembled structure 1.

The fastening member 10 of the present embodiment comprises a bolt 12 and a nut 18. The bolt 12 has a shaft 14. However, the present invention is not limited thereto. Provided that the fastening member 10 has the shaft 14, the fastening member 10 may be another male screw other than the bolt 12, and the intermediate structure 60 may be formed with a female thread which replaces the nut 18.

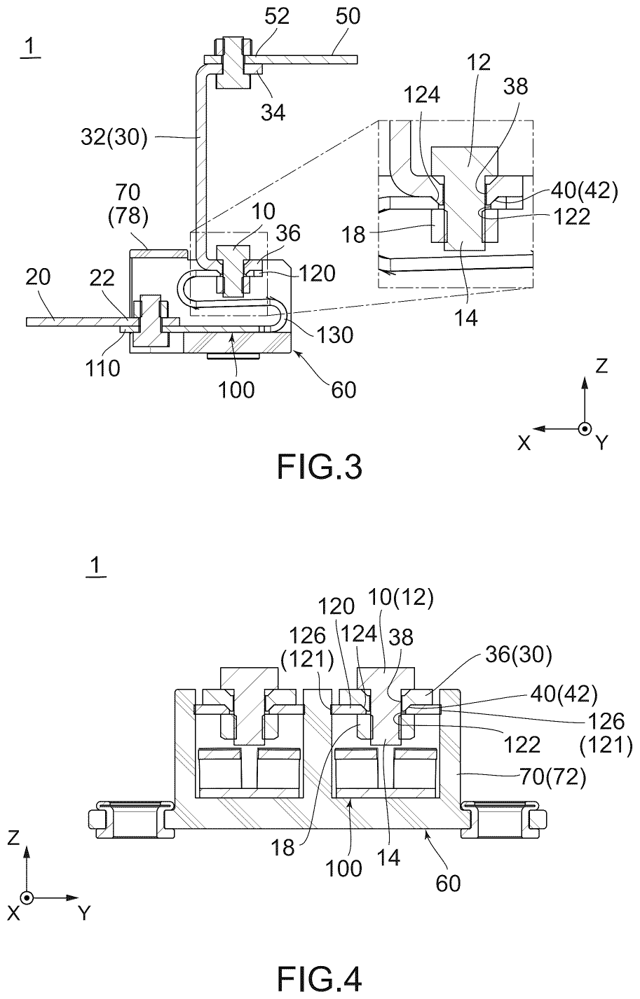

Referring to FIGS. 1 and 3, the first busbar 20 has a connection portion 22. As shown in FIGS. 1 and 3, the first busbar 20 extends linearly in the vicinity of the intermediate structure 60. However, the first busbar 20 does not need to have a linear shape. For example, the first busbar 20 may have an L-like shape.

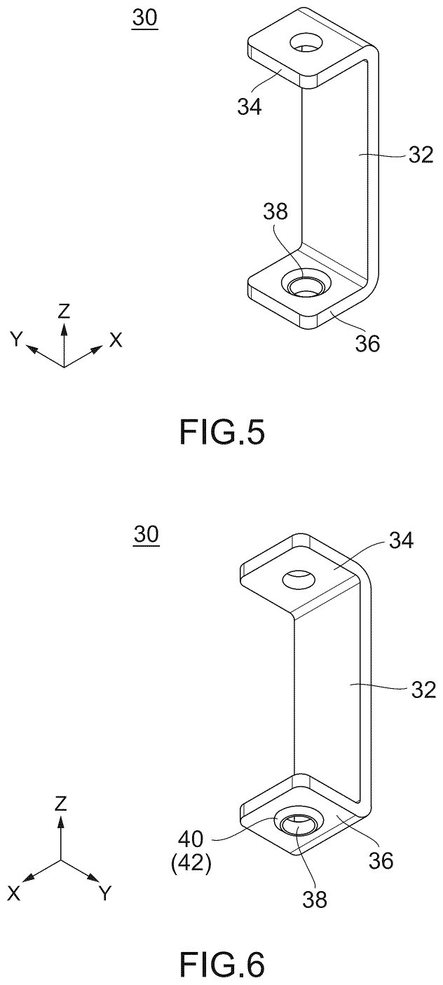

As shown in FIGS. 5 and 6, the second busbar 30 has a main portion 32 and two connection portions 34 and 36. The main portion 32 extends along the third direction (up-down direction) when the second busbar 30 is used. The connection portion 34 is located at an upper end of the thus-arranged second busbar 30. The connection portion 36 is located at a lower end of the thus-arranged second busbar 30. The lower connection portion 36 is formed with a hole portion 38. The illustrated second busbar 30 has a cylindrical projection 40. The cylindrical projection 40 is formed integrally with the hole portion 38 and extends downward from the lower connection portion 36. The cylindrical projection 40 has an outer surface which serves as a guide portion 42. The guide portion 42 has a taper shape which is tapered downward.

Referring to FIGS. 1 to 3, the third busbar 50 has a connection portion 52. As shown in FIGS. 1 and 3, the third busbar 50 extends linearly in the vicinity of the second busbar 30. However, the third busbar 50 does not need to have a linear shape. For example, the third busbar 50 may have an L-like shape.

The connection portion 52 of the third busbar 50 is connected to the upper connection portion 34 of the second busbar 30 when the structure 1 is used. The connection portion 52 and the connection portion 34 of the illustrated structure 1 are connected to each other using a bolt and a nut. However, the connection portion 52 and the connection portion 34 may be connected to each other by another method such as welding. The third busbar 50 may be formed integrally with the second busbar 30.

Referring to FIG. 3, the intermediate structure 60 is located between the first busbar 20 and the second busbar 30 and indirectly connects the first busbar 20 and the second busbar 30 to each other when the structure 1 is used. Referring to FIGS. 3, 7 and 8, the intermediate structure 60 comprises a housing 70 and a terminal 100.

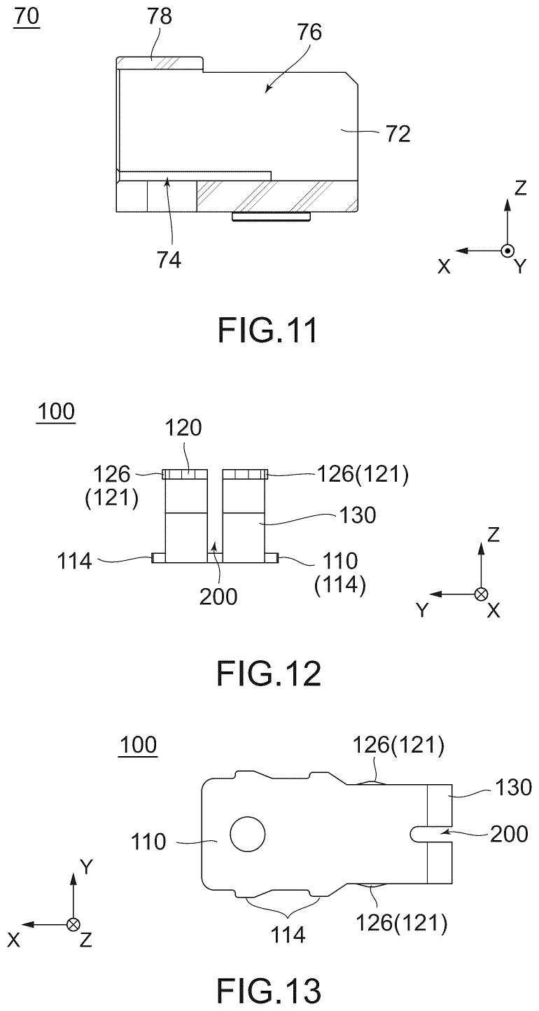

Referring to FIGS. 8, 10 and 11, the housing 70 has two side walls 72 and a top plate 78 and is formed with an accommodation portion 76. The two side walls 72 are arranged in the second direction. Each of the side walls 72 has a flat-plate shape perpendicular to the second direction. The right side wall 72 (hereafter, also referred to as “thin side wall 72”) is thinner than the left side wall 72 (hereafter, also referred to as “thick side wall 72”) in the second direction.

Each of the two side walls 72 extends in the first direction. Each of the side walls 72 is formed with a groove 74. Each of the grooves 74 extends along the first direction (front-rear direction) and opens forward of the housing 70. Each of the grooves 74 is recessed in the second direction from an inner surface of the side wall 72.

The two side walls 72 are apart from each other in the second direction. The accommodation portion 76 is located between the two side walls 72 in the second direction. The thus-located accommodation portion 76 is adjacent to each of the side walls 72 in the second direction.

The top plate 78 is located only at a front part of the housing 70 in the front-rear direction and covers only a front part of the accommodation portion 76 from above. In other words, a rear part of the accommodation portion 76 communicates with a space located over the housing 70.

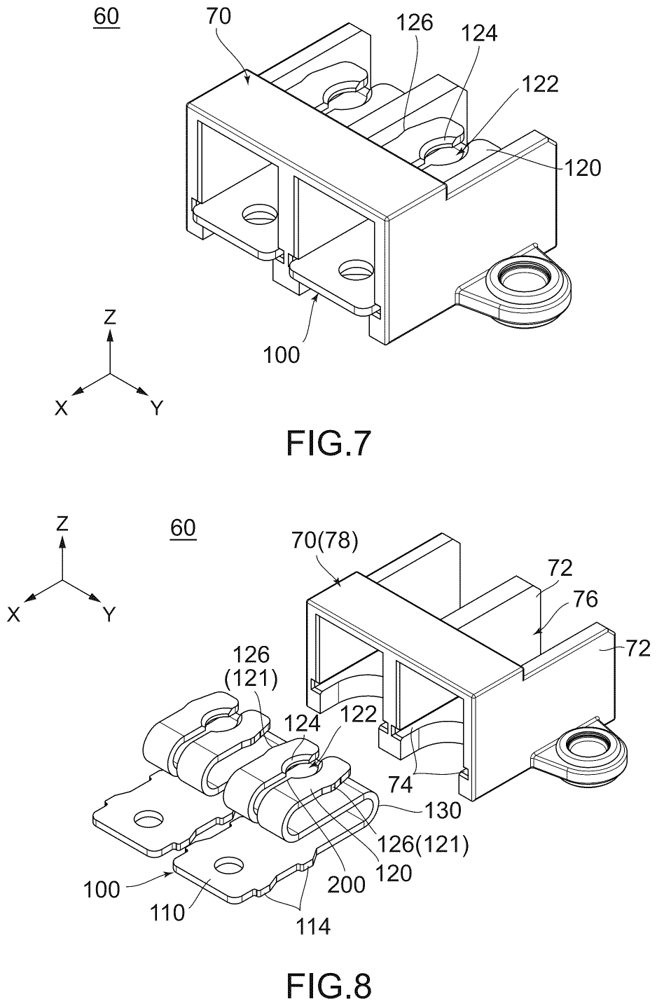

As can be seen from FIGS. 7 and 8, the housing 70 holds the terminal 100 which is at least partially accommodated in the accommodation portion 76. As shown in FIG. 8, the terminal 100 has a first connection portion 110, a second connection portion 120 and a coupling portion 130.

The illustrated first connection portion 110 is provided with a plurality of press-fit projections 114. In the present embodiment, the press-fit projections 114 are press-fit into the grooves 74 of the housing 70, and thereby the terminal 100 is held by the housing 70. However, the present invention is not limited thereto. The press-fit projections 114 may be provided on another part of the terminal 100 other than the first connection portion 110. The terminal 100 may be fixed to the housing 70 by a method different from the press-fitting.

Referring to FIGS. 1 to 3, the first connection portion 110 is configured to be connected to the first busbar 20. More specifically, the first connection portion 110 is connected to the connection portion 22 of the first busbar 20 when the structure 1 is used. The first connection portion 110 and the connection portion 22 of the illustrated structure 1 are connected to each other using a bolt and a nut. However, the first connection portion 110 and the connection portion 22 may be connected to each other by another method such as welding.

As can be seen from FIGS. 7 and 8, the second connection portion 120 is located in the rear part of the accommodation portion 76. The thus-arranged second connection portion 120 is visible from above.

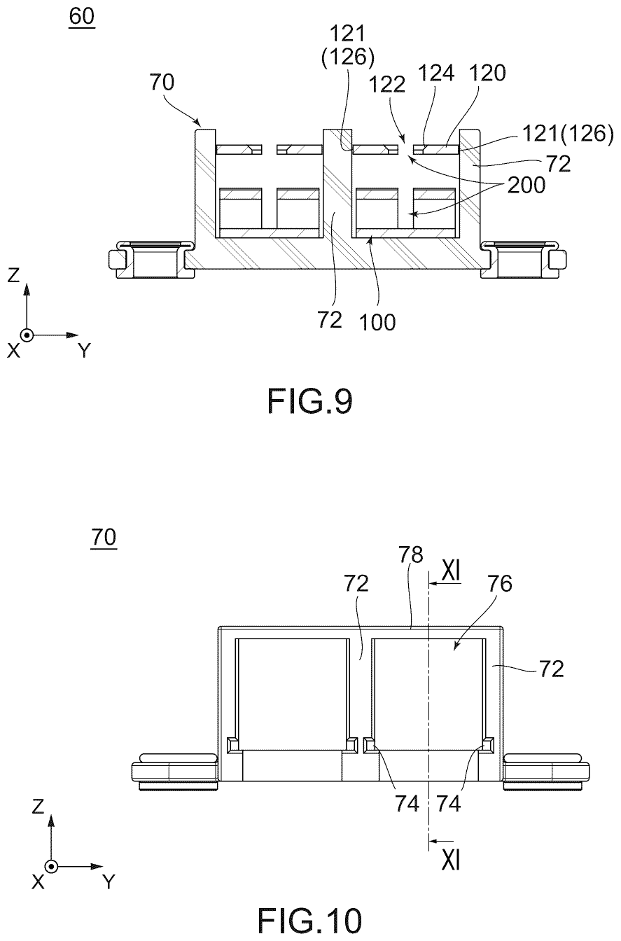

Referring to FIG. 3, when the structure 1 is used, the second connection portion 120 is connected to the lower connection portion 36 of the second busbar 30 by the fastening member 10. Thus, the second connection portion 120 is configured to be connected to the second busbar 30. Referring to FIGS. 8 and 9, the second connection portion 120 is formed with a passing hole 122. The passing hole 122 passes through the second connection portion 120 in a direction intersecting with both the first direction and the second direction. The illustrated passing hole 122 is provided with a guide portion 124. The guide portion 124 has a taper shape which is tapered downward from an upper edge of the passing hole 122.

As shown in FIG. 8, the second connection portion 120 has two end portions 121 which are located at opposite sides of the second connection portion 120 in the second direction, respectively. As described later, each of the end portions 121 serves as a pressed portion 121. Thus, the terminal 100 has pressed portions 121. Each of the end portions 121 has a projection 126. Each of the projections 126 projects outward in the second direction. Each of the projections 126 overlaps with the passing hole 122 in the first direction. In detail, each of the projections 126 of the present embodiment is located at a position which is equal to the center position of the passing hole 122 in the first direction.

Referring to FIG. 9, none of the end portions 121 of the second connection portion 120 of the present embodiment is in contact with the side walls 72 of the housing 70 under an isolated state of the intermediate structure 60 where the first busbars 20 and the second busbars 30 are not attached to the intermediate structure 60. Thus, none of the aforementioned projections 126 is in contact with the side walls 72 under the isolated state.

As shown in FIG. 8, the coupling portion 130 couples the first connection portion 110 and the second connection portion 120 together. The illustrated coupling portion 130 is resiliently deformable. As can be seen from FIGS. 3 and 8, the second connection portion 120 is movable in the third direction using resiliency of the coupling portion 130.

As can be seen from FIGS. 3 and 8, the coupling portion 130 of the present embodiment has an S-like cross-section in a plane (XZ-plane) perpendicular to the second direction. As shown in FIG. 3, the terminal 100 including the coupling portion 130 is formed of a metal plate which has a thickness thinner than a thickness of each of the first busbar 20 and the third busbar 50. Accordingly, the coupling portion 130 of the present embodiment is easily bendable.

As shown in FIG. 8, the terminal 100 of the present embodiment is formed with a slit 200. The slit 200 extends at least in the first direction through the second connection portion 120 while traversing the passing hole 122. Referring to FIGS. 3 and 4, the slit 200 is configured so that the end portions 121, or the projections 126, of the second connection portion 120 are easily movable outward in the second direction during a connection process of the second connection portion 120 and the connection portion 36 of the second busbar 30.

As shown in FIG. 8, the slit 200 is located between the end portions 121 of the second connection portion 120 in the second direction. Thus, each of the end portions (pressed portions) 121 is apart from the slit 200 in the second direction. Each of the end portions (pressed portions) 121 is moved at least in the second direction when the second connection portion 120 is resiliently deformed in accordance with a change in shape of the slit 200. Thus, each of the end portions (pressed portions) 121 is movable in the second direction in accordance with a change in shape of the slit 200.

As shown in FIGS. 12 and 13, the slit 200 of the present embodiment is formed almost all over the coupling portion 130 and extends to a bottom portion of the terminal 100. Accordingly, the end portions 121 of the illustrated second connection portion 120 are easily movable outward in the second direction.

As shown in FIG. 8, the slit 200 extends to a rear end of the second connection portion 120. Accordingly, the rear end of the second connection portion 120 can open more easily than any other part of the second connection portion 120 during the aforementioned connection process of the second connection portion 120 and the connection portion 36 of the second busbar 30.

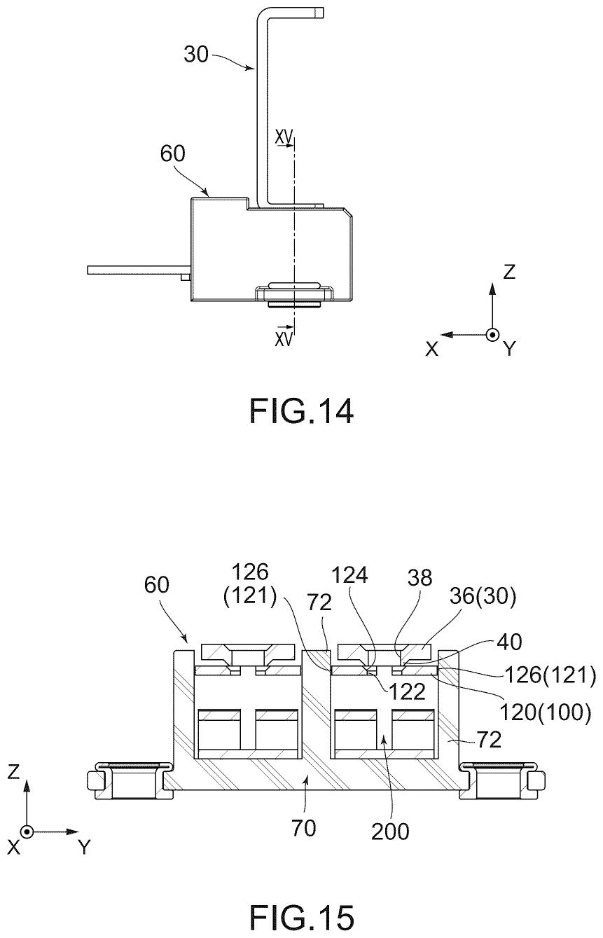

FIGS. 14 and 15 show the structure 1 which is under a state just before the second busbar 30 is connected to the second connection portion 120. The third busbar 50 connected to the second busbar 30 is not illustrated in FIG. 14. As shown in FIG. 15, under a pre-fastened state where the connection portion 36 of the second busbar 30 is mounted on the second connection portion 120 but is not fastened to the second connection portion 120 by the fastening member 10, the end portions 121 of the second connection portion 120 are not in contact with the side walls 72 of the housing 70. According to the present embodiment, the projections 126 are not in contact with the side walls 72 under the pre-fastened state.

As shown in FIGS. 3 and 4, the shaft 14 of the fastening member 10 is received in both the hole portion 38 and the passing hole 122 which are under the pre-fastened state, and then the fastening member 10 is fastened. When the fastening member 10 is fastened, the second connection portion 120 is moved in the up-down direction using resiliency of the coupling portion 130, and thereby variation of the distance between the first busbar 20 and the third busbar 50 can be absorbed.

When the fastening member 10 is under a fastened state where the fastening member 10 is fastened as shown in FIGS. 3 and 4, the shaft 14 is received in both the hole portion 38 and the passing hole 122 and extends in a shaft direction intersecting with both the first direction and the second direction. The shaft direction of the present embodiment is the third direction. However, the shaft direction may be oblique to the third direction to some extent. Under the fastened state, the second connection portion 120 is connected to the connection portion 36 of the second busbar 30. Moreover, under the fastened state, the cylindrical projection 40 is at least partially inserted in the passing hole 122. The thus-inserted cylindrical projection 40 applies a pressing force to an inner wall of the passing hole 122 and makes the slit 200 wider. As a result, the end portions (pressed portions) 121 of the second connection portion 120 are pressed against the side walls 72, respectively. The thus-pressed end portions (pressed portions) 121 at least partially bite the side walls 72 in the second direction under the fastened state (see FIG. 4). As a result, the second connection portion 120 is hardly moved in the up-down direction under the fastened state. The thus-assembled structure 1 of the present embodiment reduces damage of members such as the terminal 100 and reduces generation of noise which is conventionally regarded as a problem.

According to the intermediate structure 60 of the present embodiment, a part of the terminal 100 which bites the side wall 72 of the housing 70 under the fastened state can be limited because each of the end portions 121 of the second connection portion 120 is provided with the projection 126. In the present embodiment, the slit 200 extends to the rear end of the second connection portion 120. The rear end of the second connection portion 120 is easily movable because the slit 200 opens at the rear end of the second connection portion 120. However, the movement of the second connection portion 120 is preferred to be restricted under the fastened state of the fastening member 10. More specifically, a part of the second connection portion 120 which is located in the vicinity of the passing hole 122 is preferred to bite the housing 70 under the fastened state. Accordingly, in the present embodiment, the position of each of the projections 126 is aligned with the center position of the passing hole 122 in the first direction as described above. However, considering the reason of existence of the projections 126, each of the projections 126 may be located at a position different from the center position of the passing hole 122 to some extent in the first direction, provided that each of the projections 126 overlaps with the passing hole 122 in the first direction.

The guide portion 42 of the second busbar 30 and the guide portion 124 of the terminal 100 guide the cylindrical projection 40 when the cylindrical projection 40 is inserted into the passing hole 122. The slit 200 of the present embodiment can be smoothly made wider by the pressing force since the guide portion 42 of the second busbar 30 and the guide portion 124 of the terminal 100 are provided. However, the present invention is not limited thereto. For example, the structure 1 may be provided with only one of the guide portion 42 and the guide portion 124. The guide portion 42 and the guide portion 124 do not need to be provided depending on a size of the cylindrical projection 40 and a size of the passing hole 122.

The housing 70 of the aforementioned embodiment has two of the side walls 72. However, the number of the side walls 72 may be one. In an instance in which the number of the side walls 72 is one, only one of the end portions 121, or only one of the projections 126, bites the side wall 72 under the fastened state of the fastening member 10. More specifically, the housing 70 shown in FIG. 8 has three of the side walls 72 for the two current paths. However, the housing 70 may have only the thick side wall 72 which is located at the middle of the housing 70 in the second direction. The housing 70 of this instance does not have the thin side walls 72 which are located at opposite sides of the housing 70 in the second direction. Instead, the housing 70 may have only front parts of the thin side walls 72 which correspond to the top plate 78. According to the instances described above, only the left end portion 121 serves as the pressed portion 121 for the right terminal 100. If it is necessary for the projection 126 to bite the housing 70, the projection 126 may be provided only on the left end portion 121.

The slit 200 of the aforementioned embodiment extends to an end of the second connection portion 120 while traversing the second connection portion 120. Moreover, the slit 200 of the aforementioned embodiment is formed almost all over the coupling portion 130. However, the present invention is not limited thereto. The slit 200 may have any configuration, provided that the slit 200 extends in the first direction through the second connection portion 120 and communicates with the passing hole 122.

In the aforementioned embodiment, the second connection portion 120 is provided with the two projections 126, and the position of each of the projections 126 overlaps with the position of the passing hole 122 in the first direction. However, the present invention is not limited thereto. The position of each of the projections 126 does not need to be the illustrated position. The number of the projections 126 may be one. The projections 126 do not need to be provided in an instance in which another part of the terminal 100 other than the projections 126 bites the housing 70.

In the aforementioned embodiment, the end portions 121 of the second connection portion 120 are not in contact with the housing 70 under the isolated state of the intermediate structure 60. The thus-arranged end portions 121 are easily movable in the third direction. However, the present invention is not limited thereto. The end portions 121 of the second connection portion 120 may be in contact with the side walls 72 of the housing 70, respectively, even under the isolated state, provided that the end portions 121 are smoothly movable upward and downward within a predetermined range during the connection process of the second busbar 30 and the second connection portion 120. However, considering manufacturing tolerance of the terminal 100 and assembly tolerance of the intermediate structure 60, the end portions 121 of the second connection portion 120 are preferred to be designed so as not to be in contact with the side walls 72 of the housing 70 under the isolated state.

### Second Embodiment

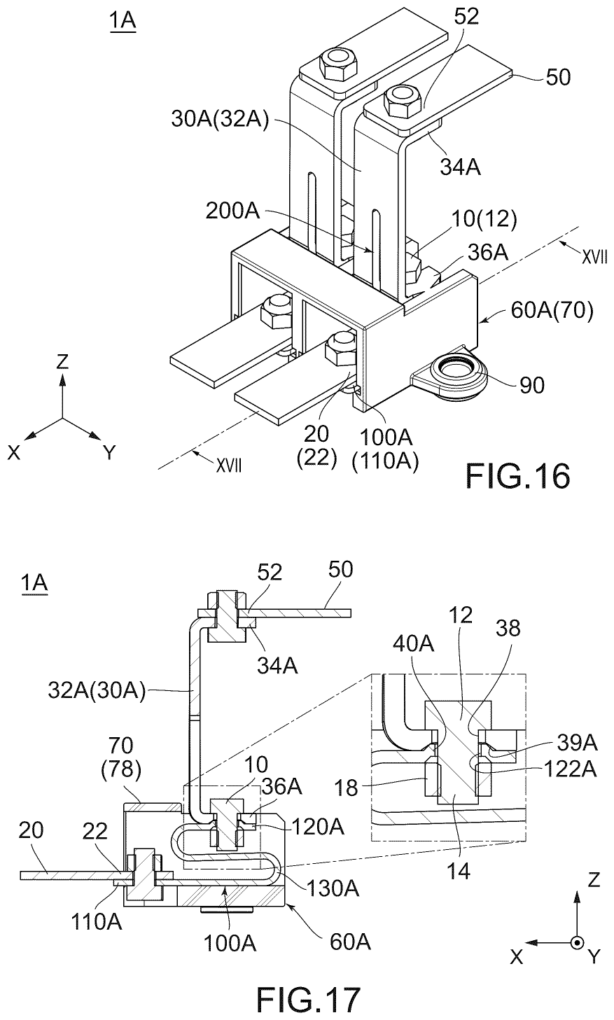

Referring to FIGS. 16 to 18 and FIGS. 1 to 4, a structure 1A according to a second embodiment of the present invention is a modification of the structure 1 of the aforementioned first embodiment. The structure 1A comprises the two fastening members 10, the two first busbars 20, two second busbars 30A, an intermediate structure 60A and the two collars 90 which are same as or similar to those of the structure 1 of the first embodiment, respectively. The aforementioned members of the structure 1A include various members and portions same as or similar to those of the structure 1. As shown in FIGS. 16 to 25, the members and the portions of the structure 1A same as those of the structure 1 of the first embodiment have reference signs same as those of the structure 1, and explanation thereof will not be made. The members and the portions of the structure 1A similar to those of the structure 1 of the first embodiment have reference signs similar to those of the structure 1, and explanation will be made mainly about the right current path.

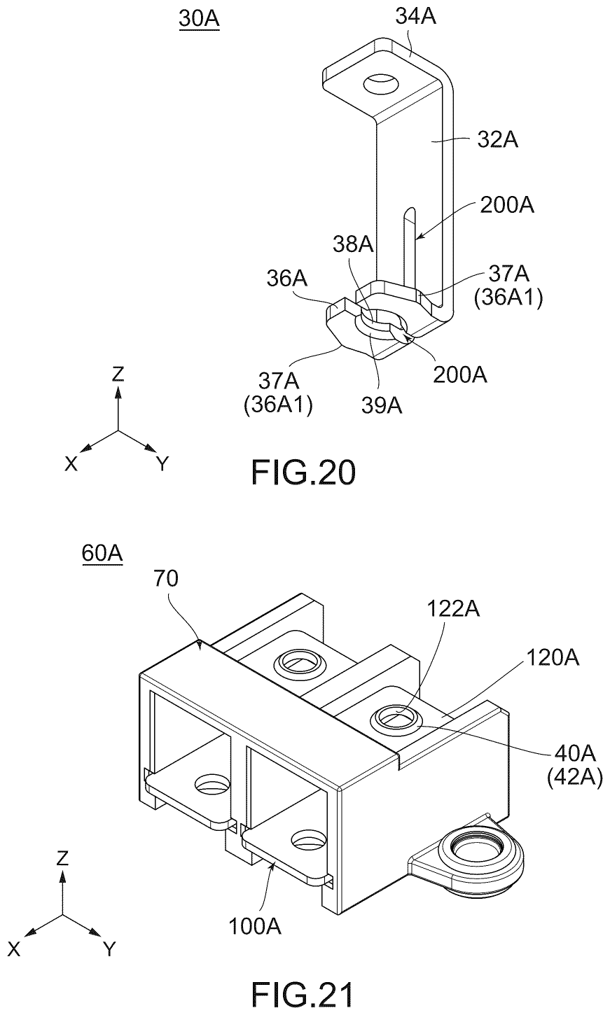

As shown in FIGS. 19 and 20, the second busbar 30A has a main portion 32A and two connection portions 34A and 36A. The connection portion 36A has two end portions 36A1 which are located at opposite sides of the connection portion 36A in the second direction, respectively. Each of the end portions 36A1 of the present embodiment serves as a pressed portion 36A1. Each of the end portions 36A1 has a projection 37A. Each of the projections 37A projects outward in the second direction. Each of the projections 37A overlaps with a hole portion 38A in the first direction. In detail, each of the projections 37A of the present embodiment is located at a position which is equal to the center position of the hole portion 38A in the first direction. In a modification in which the number of the side walls 72 of the housing 70 is one, the pressed portions 36A1 of the connection portion 36A can be modified similarly to the pressed portions 121 of the second connection portion 120 of the aforementioned first embodiment. The projections 37A of the connection portion 36A can be modified similarly to the projections 126 of the second connection portion 120 of the aforementioned first embodiment.

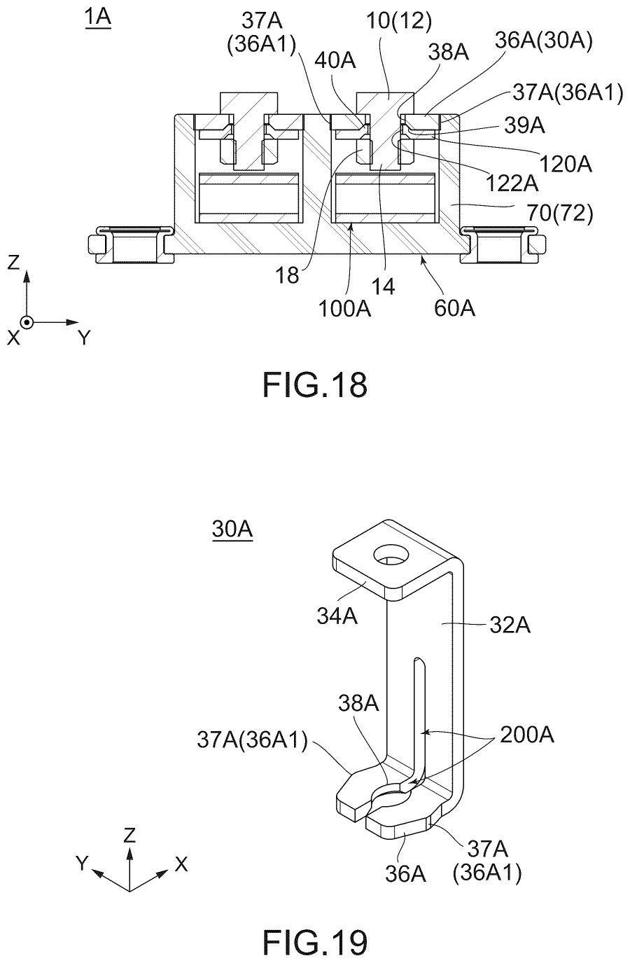

As shown in FIGS. 19 and 20, the second busbar 30A of the present embodiment is formed with a slit 200A. The slit 200A extends at least in the first direction through the lower connection portion 36A while traversing the hole portion 38A. Referring to FIGS. 17 and 18, the slit 200A is configured so that the end portions 36A1, or the projections 37A, of the connection portion 36A are easily movable outward in the second direction during a connection process of the connection portion 36A of the second busbar 30A and the second connection portion 120A.

The slit 200A of FIG. 20 is located between the end portions 36A1 of the connection portion 36A in the second direction. Thus, each of the end portions (pressed portions) 36A1 is apart from the slit 200A in the second direction. Each of the end portions 36A1 (pressed portions) is moved at least in the second direction when the connection portion 36A is resiliently deformed in accordance with a change in shape of the slit 200A. Thus, each of the end portions (pressed portions) 36A1 is movable in the second direction in accordance with a change in shape of the slit 200A.

As can be seen from FIGS. 19 and 20, the slit 200A of the present embodiment is formed over half or more of a main portion 32A. Accordingly, the end portions 36A1 of the illustrated connection portion 36A are easily movable outward in the second direction.

The slit 200A extends to a front end of the connection portion 36A. The front end of the connection portion 36A can open more easily than any other part of the connection portion 36A. However, the configuration of the slit 200A is not limited thereto. The slit 200A may have any configuration, provided that the slit 200A extends in the first direction through the connection portion 36A and communicates with the hole portion 38A.

Referring to FIG. 20, the hole portion 38A is provided with a guide portion 39A. The guide portion 39A has a taper shape which is tapered upward from a lower edge of the hole portion 38A.

As shown in FIGS. 21 to 23, the intermediate structure 60A of the present embodiment comprises the housing 70 and a terminal 100A. The terminal 100A of the present embodiment has a first connection portion 110A provided with a plurality of press-fit projections 114A, a second connection portion 120A and a coupling portion 130A. The second connection portion 120A of the terminal 100A of the present embodiment is formed with a passing hole 122A and is provided with a cylindrical projection 40A. Thus, the terminal 100A has the cylindrical projection 40A. The cylindrical projection 40A is formed integrally with the passing hole 122A of the terminal 100A and extends upward from the second connection portion 120A. Thus, the cylindrical projection 40A extends outward of the terminal 100A along the third direction. The cylindrical projection 40A has an outer surface which serves as a guide portion 42A. The guide portion 42A has a taper shape which is tapered upward.

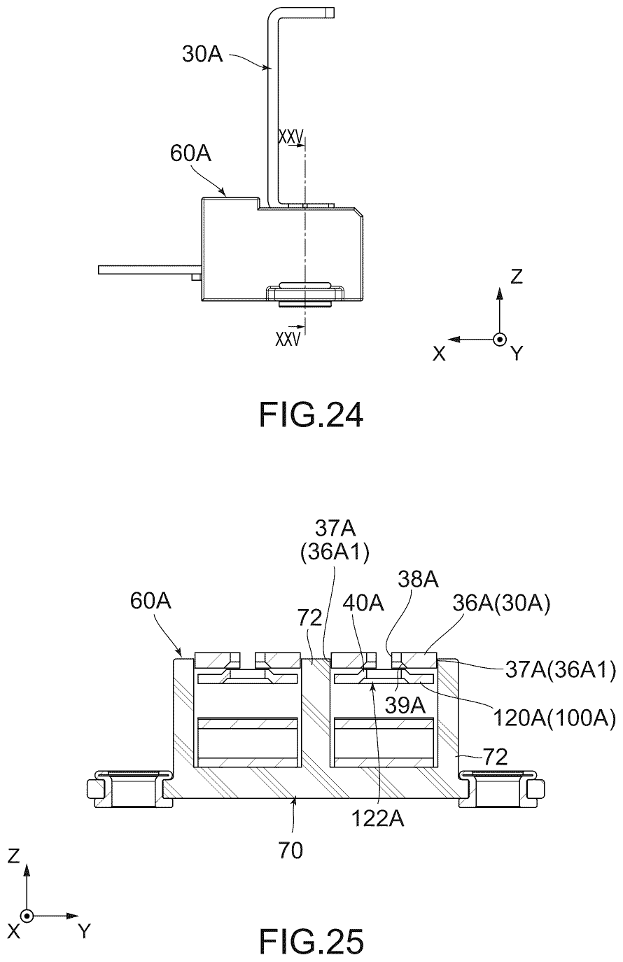

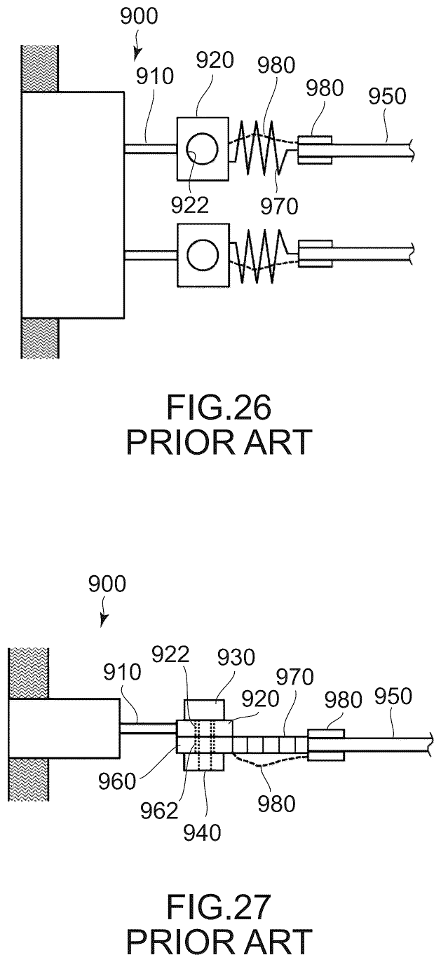

FIGS. 24 and 25 show the structure 1A which is under a state just before the second busbar 30A is connected to the second connection portion 120A. The third busbar 50 connected to the second busbar 30A is not illustrated in FIG. 24. As shown in FIG. 25, under a pre-fastened state where the connection portion 36A of the second busbar 30A is mounted on the second connection portion 120A but is not fastened to the second connection portion 120A by the fastening member 10, the end portions 36A1 of the connection portion 36A of the second busbar 30A are not in contact with the side walls 72 of the housing 70. According to the present embodiment, the projections 37A are not in contact with the side walls 72 under the pre-fastened state.

As shown in FIGS. 17 and 18, the shaft 14 of the fastening member 10 is received in both the hole portion 38A and the passing hole 122A which are under the pre-fastened state, and then the fastening member 10 is fastened. When the fastening member 10 is fastened, the second connection portion 120A is moved in the up-down direction using resiliency of the coupling portion 130A. and thereby variation of the distance between the first busbar 20 and the third busbar 50 can be absorbed.

When the fastening member 10 is under a fastened state where the fastening member 10 is fastened, the shaft 14 is received in both the hole portion 38A and the passing hole 122A and extends in a shaft direction intersecting with both the first direction and the second direction. The shaft direction of the present embodiment is the third direction. However, the shaft direction may be oblique to the third direction to some extent. Under the fastened state, the second connection portion 120A is connected to the connection portion 36A of the second busbar 30A. Moreover, under the fastened state, the cylindrical projection 40A is at least partially inserted in the hole portion 38A. The thus-inserted cylindrical projection 40A applies a pressing force to an inner wall surface of the hole portion 38A and makes the slit 200A wider. As a result, the end portions (pressed portions) 36A1 of the connection portion 36A are pressed against the side walls 72, respectively. The thus-pressed end portions (pressed portions) 36A1 at least partially bite the side walls 72 in the second direction under the fastened state (see FIG. 18). As a result, the second connection portion 120A connected to the connection portion 36A is hardly moved in the up-down direction under the fastened state. The thus-assembled structure 1A of the present embodiment reduces damage of the members such as the terminal 100A and reduces generation of noise which is conventionally regarded as a problem.

In the present embodiment, the slit 200A extends to the front end of the connection portion 36A. Considering this configuration, the position of each of the projections 37A is aligned with the center position of the hole portion 38A in the first direction. However, considering the reason of existence of the projections 37A, each of the projections 37A may be located at a position different from the center position of the hole portion 38A to some extent in the first direction, provided that each of the projections 37A overlaps with the hole portion 38A in the first direction.

The guide portion 39A of the second busbar 30A and the guide portion 42A of the terminal 100A guide the cylindrical projection 40A when the cylindrical projection 40A is inserted into the hole portion 38A. However, the present invention is not limited thereto. For example, the structure 1A may be provided with only one of the guide portion 39A and the guide portion 42A. The guide portion 39A and the guide portion 42A do not need to be provided depending on a size of the cylindrical projection 40A and a size of the hole portion 38A.

Summarizing the aforementioned first and second embodiments with reference to FIGS. 4 and 18, one of the second busbar and the terminal serves as a first member which is configured to be deformed to bite the housing 70 while a remaining one of the second busbar and the terminal serves as a second member which is configured to deform the first member. In the first embodiment, the terminal 100 serves as the first member, and the second busbar 30 serves as the second member. In the second embodiment, the second busbar 30A serves as the first member, and the terminal 100A serves as the second member.

Referring to FIG. 8, in the first embodiment, the terminal 100 is formed with the slit 200 and has the pressed portion 121. The slit 200 extends at least in the first direction through the second connection portion 120 and communicates with the passing hole 122. Referring to FIG. 6, the second busbar 30 has the cylindrical projection 40. The cylindrical projection 40 is formed integrally with the hole portion 38 and extends along the third direction. Referring to FIG. 4, the pressed portion 121 of the second connection portion 120 at least partially bites the side wall 72 in the second direction under the fastened state. Referring to FIG. 8, the slit 200 extends to the end of the second connection portion 120 in the first direction while traversing the passing hole 122. The pressed portion 121 has the projection 126 which projects in the second direction. Referring to FIG. 4, the projection 126 overlaps with the passing hole 122 in the first direction. The projection 126 bites the housing 70 under the fastened state. According to the illustrated structure 1, the cylindrical projection 40 and the passing hole 122 are provided with the guide portions 42 and 124, respectively. However, only one of the cylindrical projection 40 and the passing hole 122 may be provided with the guide portion 42 or 124. In other words, at least one of the cylindrical projection 40 and the passing hole 122 may be provided with the guide portion 42 or 124. Accordingly, the guide portion 42 or 124 guides the cylindrical projection 40 when the cylindrical projection 40 is at least partially inserted into the passing hole 122.

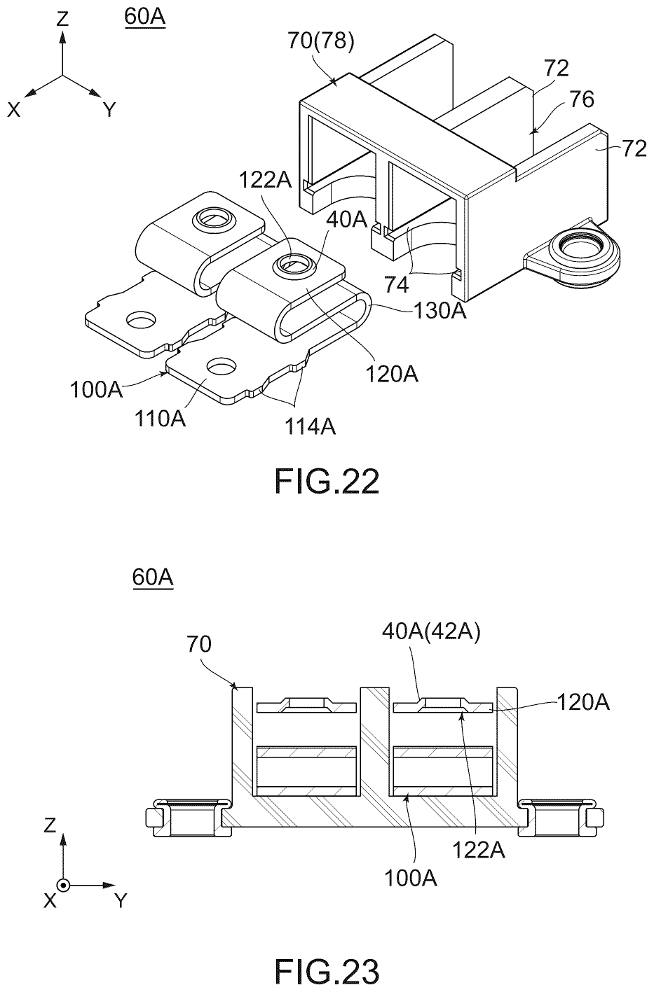

Referring to FIG. 19, in the second embodiment, the second busbar 30A is formed with the slit 200A and has the pressed portion 36A1. The slit 200A extends at least in the first direction through the connection portion 36A and communicates with the hole portion 38A. Referring to FIG. 22, the terminal 100A has the cylindrical projection 40A. The cylindrical projection 40A is formed integrally with the passing hole 122A and extends along the third direction. Referring to FIG. 18, the pressed portion 36A1 of the connection portion 36A at least partially bites the side wall 72 in the second direction under the fastened state. Referring to FIG. 20, the slit 200A extends to the end of the connection portion 36A in the first direction while traversing the hole portion 38A. The pressed portion 36A1 has the projection 37A which projects in the second direction. The projection 37A overlaps with the hole portion 38A in the first direction. Referring to FIG. 18, the projection 37A bites the housing 70 under the fastened state. Referring to FIG. 18 together with FIG. 21, according to the illustrated structure 1A, the cylindrical projection 40A and the hole portion 38A are provided with the guide portions 42A and 39A, respectively. However, only one of the cylindrical projection 40A and the hole portion 38A may be provided with the guide portion 42A or 39A. In other words, at least one of the cylindrical projection 40A and the hole portion 38A may be provided with the guide portion 42A or 39A. Accordingly, the guide portion 42A or 39A guides the cylindrical projection 40A when the cylindrical projection 40A is at least partially inserted into the hole portion 38A.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A structure comprising a fastening member, a first busbar, a second busbar and an intermediated structure, wherein;
the fastening member has a shaft;
the second busbar has a connection portion;
the connection portion of the second busbar is formed with a hole portion;
the intermediated structure is located between the first busbar and the second busbar and indirectly connects the first busbar and the second busbar to each other;
the intermediated structure comprises a terminal and a housing;
the housing has a side wall and is formed with an accommodation portion;
the side wall extends in a first direction;
the accommodation portion is adjacent to the side wall in a second direction perpendicular to the first direction;
the housing holds the terminal which is at least partially accommodated in the accommodation portion;
the terminal has a first connection portion, a second connection portion and a coupling portion;
the coupling portion is resiliently deformable and couples the first connection portion and the second connection portion together;
the first connection portion is connected to the first busbar;
the second connection portion is formed with a passing hole;
one of the second busbar and the terminal serves as a first member while a remaining one of the second busbar and the terminal serves as a second member;
the first member is formed with a slit and has a pressed portion;
the slit extends at least in the first direction through the connection portion of the first member or the second connection portion of the first member and communicates with the hole portion of the first member or the passing hole of the first member;
the pressed portion is apart from the slit in the second direction and is movable in the second direction in accordance with a change in shape of the slit;
the second member has a cylindrical projection;
the cylindrical projection is formed integrally with the hole portion of the second member or the passing hole of the second member and extends along a third direction perpendicular to both the first direction and the second direction;
the fastening member is under a fastened state where the fastening member is fastened;
under the fastened state, the shaft is received in both the hole portion and the passing hole and extends in a shaft direction intersecting with both the first direction and the second direction;
under the fastened state, the second connection portion is connected to the connection portion of the second busbar; and
under the fastened state, the cylindrical projection is at least partially inserted in the hole portion of the first member or the passing hole of the first member and makes the slit wider, and the pressed portion at least partially bites the side wall in the second direction.

2. The structure as recited in claim 1, wherein:
the terminal serves as the first member;
the second busbar serves as the second member;
the terminal is formed with the slit and has the pressed portion;
the slit extends at least in the first direction through the second connection portion and communicates with the passing hole;
the second busbar has the cylindrical projection;
the cylindrical projection is formed integrally with the hole portion and extends along the third direction; and
the pressed portion of the second connection portion at least partially bites the side wall in the second direction under the fastened state.

3. The structure as recited in claim 1, wherein:
the second busbar serves as the first member;
the terminal serves as the second member;
the second busbar is formed with the slit and has the pressed portion;
the slit extends at least in the first direction through the connection portion and communicates with the hole portion;
the terminal has the cylindrical projection;
the cylindrical projection is formed integrally with the passing hole and extends along the third direction; and
the pressed portion of the connection portion at least partially bites the side wall in the second direction under the fastened state.

4. The structure as recited in claim 2, wherein:
the slit extends to an end of the second connection portion in the first direction while traversing the passing hole;
the pressed portion has a projection which projects in the second direction;
the projection overlaps with the passing hole in the first direction; and
the projection bites the housing under the fastened state.

5. The structure as recited in claim 3, wherein:
the slit extends to an end of the connection portion in the first direction while traversing the hole portion;
the pressed portion has a projection which projects in the second direction;
the projection overlaps with the hole portion in the first direction; and
the projection bites the housing under the fastened state.

6. The structure as recited in claim 2, wherein:
at least one of the cylindrical projection and the passing hole is provided with a guide portion; and
the guide portion guides the cylindrical projection when the cylindrical projection is at least partially inserted into the passing hole.

7. The structure as recited in claim 3, wherein:
at least one of the cylindrical projection and the hole portion is provided with a guide portion; and
the guide portion guides the cylindrical projection when the cylindrical projection is at least partially inserted into the hole portion.

8. An intermediate structure configured to be located between the first busbar and the second busbar of the structure as recited in claim 1 and to indirectly connect the first busbar and the second busbar to each other, wherein:
the intermediated structure comprises a terminal and a housing;
the housing has a side wall and is formed with an accommodation portion;
the side wall extends in a first direction;
the accommodation portion is adjacent to the side wall in a second direction perpendicular to the first direction;
the housing holds the terminal which is at least partially accommodated in the accommodation portion;
the terminal has a first connection portion, a second connection portion and a coupling portion;
the coupling portion is resiliently deformable and couples the first connection portion and the second connection portion together;
the first connection portion is configured to be connected to the first busbar;
the second connection portion is formed with a passing hole;
the second connection portion is configured to be connected to the second busbar;
the second connection portion is movable in a third direction perpendicular to both the first direction and the second direction; and
the passing hole passes through the second connection portion in a direction intersecting with both the first direction and the second direction.

9. The intermediate structure as recited in claim 8, wherein:
the terminal is formed with a slit and has a pressed portion;
the slit extends at least in the first direction through the second connection portion of the terminal and communicates with the passing hole of the terminal; and
the pressed portion is apart from the slit in the second direction and is movable in the second direction in accordance with a change in shape of the slit.

10. The intermediate structure as recited in claim 8, wherein:
the terminal has a cylindrical projection; and
the cylindrical projection is formed integrally with the passing hole of the terminal and extends outward of the terminal along a third direction perpendicular to both the first direction and the second direction.

11. The intermediate structure as recited in claim 8, wherein the coupling portion has an S-like cross-section in a plane perpendicular to the second direction.
